(19) United States
(12) Patent Application Publication
(10) Pub. No.: US 2020/0158686 A1
(43) Pub. Date: May 21, 2020

(54) ELECTROPHORESIS APPARATUS WITH PLANAR ELECTRODE CONTACT SURFACES

(71) Applicant: HELENA LABORATORIES CORPORATION, BEAUMONT, TX (US)

(72) Inventors: Jeffrey Allen SPENCER, Lumberton, TX (US); Henry Alfred GARSEE, Kountze, TX (US)

(73) Assignee: HELENA LABORATORIES CORPORATION, Beaumont, TX (US)

(21) Appl. No.: 16/635,177

(22) PCT Filed: Aug. 3, 2018
(86) PCT No.: PCT/US2018/045095

§ 371 Date: Jan. 30, 2020

Related U.S. Application Data
(60) Provisional application No. 62/542,886, filed on Aug. 9, 2017.

(51) Int. Cl. G01N 27/447

(52) U.S. Cl. CPC G01N 27/44747; G01N 27/44717

(57) ABSTRACT

An electrophoresis apparatus for separating charged molecules of a fluid comprises a support surface, a gel substrate disposed on the support surface having spaced apart parallel generally planar gel contact surfaces, and at least a first electrodes having generally planar electrode contact surface in contact with a respective generally planar gel contact surface. The electrode generally planar contact surface area is from about 35% to about 100% of the area of the corresponding generally planar contact gel surface.

This disclosure relates to the field of electrophoresis. Electrophoresis is the movement of electrically charged molecules that are placed in a support medium and then subjected to an electrical field. The charged molecules migrate through the support medium and across an electric field whereby separation of the molecules depends, at least in part, on their size.

Electrophoresis provides analytical information on various biological molecules. It is widely used by medical laboratories for the analysis of a variety of samples such as for example, blood proteins, DNA, RNA, immunoglobins, hemoglobin, cholesterol, lipoproteins, isoenzymes and cerebrospinal fluid proteins (CSF). These samples typically include large molecules or components that have an electrical charge. Electrophoresis allows movement of the electrically charged components when subjected to an electrical field. During electrophoresis, the samples to be tested are placed within a support medium that is electrically connected to an electrical source. The support medium such as a gel provides a solid or semi-solid porous layer or lattice through which the electrically charged molecules migrate across the electrical field. A buffer solution is typically used to submerge the samples and support medium and maintain and monitor pH level. The support medium is typically a backing layer treated with a gel substance. One example of the gel substance is agarose.

Electrophoresis systems include a positive electrode and a negative electrode, which are placed in an electrical circuit to create an electrophoretic field between the electrodes. The charged molecules of the sample will flow through the electrophoretic field within the porous structure of the gel based on the attraction of the charged molecule to the electrode having an opposite charge. The samples may be placed at or near one end of the electrophoretic field into one or more sample wells near one of the two electrodes, such as for example the negative electrode or cathode. When the electrical field is activated, the electrically charged components will move across the electrical field based on their attraction to the oppositely charged electrode. The distance that each component travels across the electrical field will depend on various factors including respective size or mass. The separated component will form a series of bands on the support medium that may extend from one end of the medium to the other. Viewing of the bands may be aided by various drying and/or staining techniques and/or washing or removal of the buffer solution. Each band typically represents an amount of a molecule having a certain size and may be more or less distinct depending on the concentration of such molecule. The bands may be further examined and analyzed by various techniques such as densitometry and/or other methods.

One problem that occurs when conducting electrophoresis is the tendency for heat to accumulate at the electrode. During operation of the electrical field, heat tends to accumulate where the electrode contacts the support medium or gel. Too much heat can cause the gel to expel or express the fluid that is contained within the gel. This expulsion of fluid from the gel is also known as syneresis, which reduces the efficacy of the gel to allow molecules to migrate through its porous structure. When too much fluid is expressed from the gel, the expelled fluid creates dry spots through which no migration can occur, and/or the expelled fluid may cause creation of an alternate electrical path with less resistance through which the charged molecules will flow. The electrical flow bypasses or short circuits the desired electrophoretic field through the gel in lieu of the electrical path through the expelled fluid. Movement of the charged molecules through the expelled fluid thus fails to cause the desired separation in the desired location based on molecular size. Moreover, the expelled fluid may flow over the gel and interfere with the molecular separation results that transpired before the short circuit occurred thereby tainting the test results and requiring the test to be rerun. Thus, this short-circuiting effect resulting from the expelled fluid creates undesired results and wastes time and energy.

Prior electrophoresis processes have mitigated the effect of the heat causing dry areas and short circuits by using capped gel ends on the support medium in combination with a round cross-sectional electrode. One capped or enlarged gel end is placed at each side of the support medium adjacent each electrode. The capped end includes an extra amount of support medium or gel that extends above the electrophoretic medium along substantially the entire length of the electrode. The capped end is above the nominal thickness of the gel and thus when the electrode is placed in contact with the capped end, the electrode is elevated above the nominal thickness of the gel. The capped ends facilitate the heat buffering capacity of the gel by providing a thermal heat sink that helps avoid expulsion of fluid that may otherwise lead to syneresis and short circuits that give poor testing results. However, the capped gel ends require additional preparation of the support medium because additional layers of gel must be applied to each end of the support medium.

Accordingly, there is a need to provide an electrophoresis apparatus and method that mitigates heat and avoid syneresis at the electrode surface.

In one embodiment, the present disclosure is directed to an electrophoresis apparatus for separating charged molecules within a fluid comprising a support surface and a gel substrate disposed on the support surface. The gel substrate has spaced apart parallel gel blocks disposed. Each gel block includes a generally planar uppermost gel contact surface. The apparatus further includes a first electrode and a second electrode wherein each electrode has a cross-sectional geometric shape that includes a generally planar electrode contact surface. The electrode contact surface is in direct contact with a respective gel contact surface.

In another aspect of the present disclosure each electrode contact surface has a surface area that is from about 35% to about 100% of the corresponding gel contact surface area.

In a further aspect of the present disclosure, the apparatus includes two and only two electrodes.

In accordance with another aspect of the present disclosure, enlarged gel areas at each end of the gel substrate are not utilized and the gel contact surfaces are defined as the end portions of the gel substrate.

In accordance with various aspects of the present disclosure, the apparatus includes at least one of the first and second electrodes having a cross-sectional polygonal shape.

In another aspect of the present disclosure, at least one of the first and second electrodes may have a cross-sectional square shape or a cross-sectional triangular shape.

In another aspect of the present disclosure, at least one of the first and second electrodes has a cross-sectional shape that has at least one generally planar side as the electrode contact surface and at least one curved side, and the generally planar side forms the electrode contact surface.

In a further aspect of the present disclosure, the curved side of each electrode has a substantially circular shape that connects to the generally planar side of each electrode which generally planar side forms the electrode contact surface.

In a yet further aspect of the present disclosure, each electrode has a cross-sectional shape that has two generally planar sides, one of which forms the electrode contact surface and at least one curved side to connect the two generally planar sides.

In a still further aspect of the present disclosure, each electrode has a cross-sectional shape that has two opposed generally planar sides, one of which forms the electrode contact surface and two opposed curved sides to connect the two generally planar sides.

In other aspects of the present disclosure, the fluid is prepared from red blood cells and the molecules to be separated include types of hemoglobin. Moreover, the support medium may be an agarose gel.

In another aspect of the present disclosure the electrodes are formed from carbon.

The apparatus further includes a buffer solution that immerses the gel substrate. The buffer solution provides an alkaline in which the gel substrate is immersed during electrophoresis.

The following drawings form part of the present specification and are included to further demonstrate certain aspects of the present disclosure. The disclosure may be better understood by reference to one or more of these drawings in combination with the detailed description of specific embodiments presented herein.

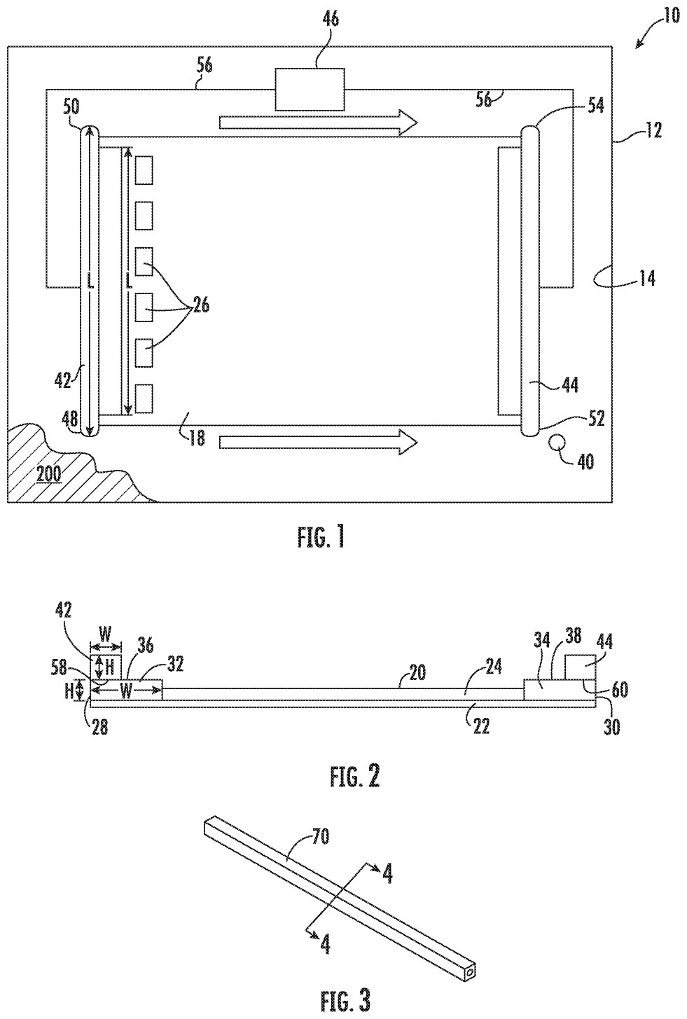

FIG. 1 is a top plan view of an electrophoresis apparatus in one embodiment of the present disclosure.

FIG. 2 is an elevation view of FIG. 1 with portions of the apparatus removed to illustrate electrodes and a gel substrate.

FIG. 3 is an isometric view an electrode in accordance with an embodiment of the present disclosure.

FIGS. 4-15 are alternate embodiments of electrodes showing various cross-sectional shapes.

Referring to FIGS. 1-3, one non-limiting embodiment of an electrophoresis apparatus, generally indicated at 10, includes a housing 12. The housing 12 may contain various components in accordance with typical clinical laboratory testing and sampling techniques or to facilitate such testing. Other components may include a user interface screen, data entry pad, touchpad, controls, sample holders, sample delivery devices, cover and/other components.

The interior of the housing 12 includes a chamber 14 and a support surface 18. The support surface 18 includes a sampling area for placing a gel substrate 20. The gel substrate 20 includes a base layer 22 such as a plastic or polymeric film or sheet which is coated with a solid or semi-solid gel layer 24, such as but not limited to an agarose gel. The gel substrate 20 has a porous structure that enables charged molecules to flow therethrough when the molecules are subjected to the electrical field. Other types of gels may also be used.

The gel substrate 20 may include a plurality of wells 26 formed therein to receive fluid samples for testing. As shown in FIG. 2, the gel layer 24 extends over the base layer 22 from a first end 28 to a second end 30. The gel layer 24 may include spaced-apart first and second gel blocks or gel caps 32, 34. Each gel block or gel cap is positioned at a corresponding end of the gel substrate. Gel block 32 has a generally planar upper contact surface 36 and gel block 34 has a generally planar upper contact surface 38.

The gel blocks or gel caps may be formed separately from the gel layer 24 and placed thereon or may be formed concurrently with the formation of the gel layer.

In one embodiment, the top of the gel layer 24 is in a first horizontal plane and the generally planar surfaces 36, 38 are in a second horizontal plane that is vertically above the first horizontal plane.

In another embodiment, gel caps or gel blocks are not utilized and in such an embodiment the generally planar surfaces 36, 38 are at the ends of the gel layer 24 and may be in the same horizontal plane as the top of the gel layer 24.

In all embodiments, surfaces 36, 38 are referred to as generally planar gel contact surfaces.

As used herein “generally planar” refers to a surface that is preferably flat, level, straight or the like and/or which preferably lies in a single plane. It should be understood, however, that gel is preferably formed of a porous, non-rigid material such as agarose gel. Therefore, the term “generally planar” must be understood in the context of the material of which the gel block is formed. Accordingly, “planar” and “generally planar” when referring to the surfaces 36 and 38 should not be interpreted in the strict context of mathematics (geometry).

Each of the gel blocks has a length L (See FIG. 1) a width W and a height H (see FIG. 2). An alignment pin 40 may be provided on the support surface 18 (and/or the gel substrate 20 may be provided with an opening in an appropriate location to receive the pin) to more accurately position the substrate.

The apparatus 10 further includes a first electrode 42 and a second electrode 44. The electrodes 42, 44 are electrically connected to an electrical source 46 such as a battery or other power source. When the power is activated, an electrical circuit induces an electrical field between the electrodes. The first electrode 42 has a first end 48 and second end 50 (FIG. 1) and the second electrode has a first end 52 and a second end 54 (FIG. 1). Each electrode 42, 44 has a length L (FIG. 1), a width W and a height H (FIG. 2). An electrical connection 56 to the electrical source may, be provided at one or more electrode ends. Although two and only two electrodes 42, 44 are shown in FIGS. 1-2, additional electrodes may be used depending on the nature of the electrophoresis system.

In FIG. 2, the first electrode 42 has a first electrode contact surface 58 extending along the length of the electrode between the first and second ends 48, 50. Similarly, the second electrode 44 has a second electrode contact surface 60 extending between the first and second ends 52, 54. Each electrode contact surface 58, 60 is disposed on a bottom of the corresponding electrode 42, 44, The electrodes are formed of electrically conductive material and may preferably be formed of carbon. The contact surface of each electrode is a generally planar surface area. The generally planar surface area of each carbon electrode, therefore, may have a greater degree of geometrical and/or manufacturing precision than “generally planar” when that term is used to refer to the surface of the agarose gel since carbon has more rigidity than the porous, non-rigid gel.

Preferably, the generally planar lower contact surface area of each electrode is between about 35% to about 100% of the generally planar upper gel contact surface area 36, 38, This numeric range include all values from, and including, the lower value and the upper value and non-integer values.

The first and second electrodes 42, 44 may have various overall geometric shapes, when viewed from the end and/or in cross-section, as long as the electrodes have a generally planar contact area. The term “geometric shape” as used herein, refers to a three-dimensional shape or a three-dimensional configuration having a length, a width and a height. The geometric shape can be a regular three-dimensional shape, an irregular three-dimensional shape, and combinations thereof, Nonlimiting examples of regular three-dimensional shapes include cubes and prisms. It is understood that when the geometric shape of the electrode is a prism, the prism can have a cross-sectional shape that is a regular polygon, or an irregular polygon having three, four, five, six, seven, eight, nine, 10 or more sides. Nonlimiting examples of prismatic cross-sectional shapes include square, rectangular, trapezoidal, rhomboid, triangular, hexagonal, octagonal, as shown in the examples of FIGS. 2-8 and 14-15.

It is further understood that when the geometric shape of the electrode is an irregular three-dimensional shape, the irregular three-dimensional shape may further include polygonal shapes having at least one curved side and at least one generally planar side. Nonlimiting examples of such polygonal shapes include cylindrical, ovoid and/or elliptical shapes or portions thereof that have at least one generally planar side.

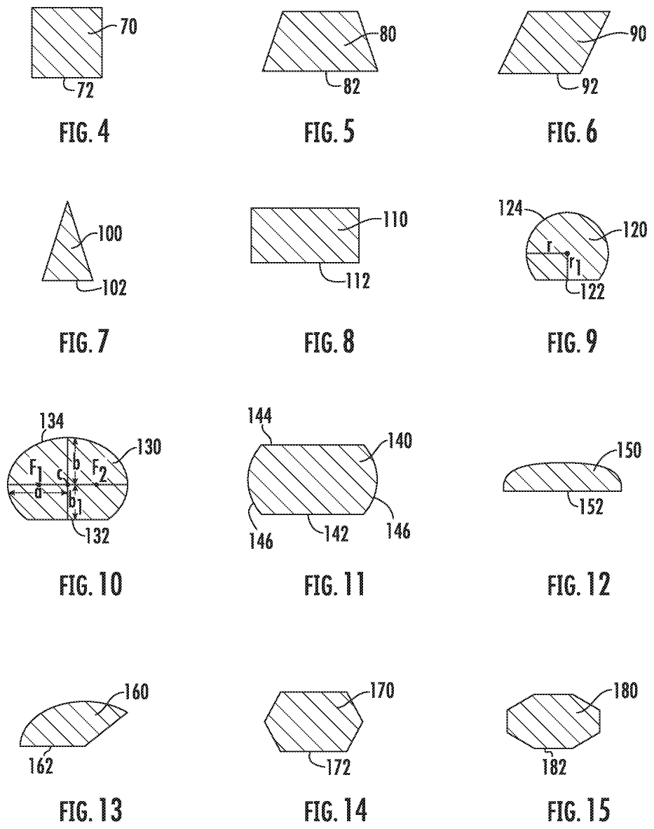

In FIGS. 3-4, a square-shaped electrode 70 includes a generally planar electrode contact surface 72 for direct contact with a generally planar gel contact surface. By way of example, a trapezoidal-shaped electrode 80 includes an electrode contact surface 82 in FIG. 5. In FIG. 6, a rhomboid-shaped electrode 90 includes an electrode contact surface 92. FIG. 7 includes a triangular-shaped electrode 100 having an electrode contact surface 102. FIG. 8 includes a rectangular-shaped electrode 110 having an electrode contact surface 112.

In accordance with further aspects of the present disclosure, an electrode 120 in FIG. 9 has an irregular polygonal cross-section shape that includes one generally planar side 122 and one curved side 124. The electrode 120 defines a substantially circular cross section except for the generally planar side 122. The planar side is formed by a chord or line segment that joins two points of the circle. A “circle” as used herein, is a closed plane curve consisting of all points at a given distance from a point within it called the center. A radius (r) for the circle is the distance from the center of the circle to any point on the circle. In FIG. 9, the generally planar side 122 is spaced a distance (n) from the center which is less than the circle radius (r) and is connected at opposed ends to the curved side 124, thereby forming a cross-sectional shape may also be referred to a circle with a flattened side. Other variations of the curved side are also possible including but not limited to one or more of convex or concave curves or any combination thereof. A “generally planar” side may include a deliberate curve as long as the radius of curvature is sufficiently large such that the between about 35% to about 100% of the electrode contact area is in contact with the corresponding gel surface area.

An electrode 130 in FIG. 10 is polygonal shape that is substantially elliptical in cross-section except that it includes one generally planar side 132 that is formed by a chord or line segment that joins two points of the ellipse. An “ellipse,” as used herein, is a plane curve such that the sums of the distances of each point in its periphery from two fixed points, the foci, are equal. The ellipse has a center which is the midpoint of the line segment linking the two foci. The ellipse has a major axis (the longest diameter through the center). The minor axis is the shortest line through the center. The ellipse center is the intersection of the major axis and the minor axis. As used herein, the diameter (d) for the ellipse is the major axis. A semi-major axis (a) is the distance from the ellipse center to one end of the major axis. A semi-minor axis (b) is the distance from the center to one end of the minor axis. In FIG. 10, the planar side forms a line segment along a chord of the ellipse and a distance (b₁) from the center that is less than the semi-minor axis (b). Thus, the elliptical shape electrode in FIG. 10 includes one generally planar side that is connected via opposed ends by a curved elliptical side 134. Other shapes, curvatures and configurations are also possible and other chordal locations may be chosen for the line segments.

In FIG. 11, an electrode 140 has a polygonal cross-section shape having a generally planar electrode contact surface 142 formed on a lowermost surface. An upper planar surface 144 is spaced apart and parallel to the electrode contact surface 142. Two opposed curved convex sides 146 connect the opposite ends of the upper and lower planar surfaces. Other geometric shapes and configurations are also possible such as rectangular with rounded edges, concave curved surfaces and/or combinations thereof.

In FIG. 12, an electrode 150 has a polygonal cross-section shape that is substantially ovoid. A generally planar electrode contact surface 152 is formed on a bottom of the electrode 150. In FIG. 13, an electrode 160 has a cross-sectional shape including a generally planar electrode contact surface 162 on a bottom thereof. An intersecting planar side 164. One curved side 166 connects the two planar sides. The polygonal cross-section forms a pie-shape with an obtuse angle. Other shapes and configurations are also possible. FIGS. 14-15 respectively show electrodes 170, 180 each having polygonal cross-sections of a hexagon and octagon, respectively, each having a corresponding generally planar electrode contact surface 172, 182 along their lowermost contact surface. Other geometric shapes and configurations are also possible. In one alternate embodiment the two electrodes have identical cross-sectional shapes.

Preparation for the electrophoresis process includes, among other steps, filing the appropriate wells 26 with sample fluids and filling portions of the chamber 14 with a buffer solution 200 (FIG. 1). The buffer solution is used to maintain the gel substrate at an appropriate pH level and immerse the gel substrate and maintain the electrophoretic field during operation. One of the first and second electrodes 42, 44 (such as first electrode 42) may be a negative electrode (cathode) and the other of the first and second electrodes (such as second electrode 44) may be a positive electrode (anode). An electrical field may be induced to allow negatively charged particles to flow through the porous gel substrate from the negative electrode to the positive electrode, in accordance with the direction shown in FIG. 1. During electrophoresis, heat from the electrode 42, 44 is spread over the large generally planar contact surface area of the electrodes, i.e., contact surfaces 58, 60. The large electrode contact surface areas enable heat mitigation. As used herein, “heat mitigation” is the dispersion of heat along the entire electrode contact surface so as to avoid or minimize syneresis. The heat mitigation provided by the electrode contact surface area helps to keep the temperature of the gel substrate lower to minimize or avoid fluid expression of the gel layer. The gel substrate provides for migration of molecules through the electrophoretic field to allow separation of the charged molecules based on size.

In one aspect of the present disclosure, the electrophoresis apparatus may be used for testing alkaline hemoglobin assays for separation of different types of hemoglobin molecules that migrate across the electrophoretic field. Other testing applications are also possible.

All such similar substitutes and modifications apparent to those skilled in the art are deemed to be within the concept, spirit, and scope as defined by the appended claims.

1. An electrophoresis apparatus for separating charged molecules of a fluid comprising:
a support surface;
a gel substrate disposed on the support surface, the gel substrate having a first generally planar gel contact surface positioned a first distance above said support surface, said gel substrate formed of an agarose gel and including a buffer solution;
at least one gel block disposed on the gel substrate, the gel block formed of an agarose gel and including a buffer solution, the gel block having a generally planar upper surface positioned a second distance above said support surface, said second distance being greater than said first distance; and
at least a first electrode having a cross-sectional geometric shape that includes a generally planar electrode contact surface, the generally planar electrode contact surface in direct contact with the generally planar upper surface of said gel block.

2. (canceled)

3. An apparatus in accordance with claim 1, wherein the apparatus includes first and second gel blocks disposed on the gel substrate, each of said first and second gel blocks formed of an agarose gel and including a buffer solution, and each having a generally planar upper surface positioned a second distance above said support surface, said second distance being greater than said first distance; and
at least first and second electrodes, each electrode having a cross-sectional geometric shape that includes a generally planar electrode contact surface, each generally planar electrode contact surface in direct contact with a generally planar upper surface of one of said gel blocks.

4. An apparatus in accordance with claim 1, wherein the area of the generally planar electrode contact surface is from about 35% to about 100% of the area of the generally planar upper surface of said gel block.

5. (canceled)

6. (canceled)

7. (canceled)

8. An apparatus in accordance with claim 3, wherein each of the first and second electrodes has the same cross-sectional shape.

9. An apparatus in accordance with claim 1, wherein the fluid is prepared from red blood cells and the molecules to be separated includes types of hemoglobin.

10. (canceled)

11. (canceled)

12. An apparatus in accordance with claim 1, wherein the buffer solution provides an alkaline pH in which the gel substrate is immersed during electrophoresis.

13. An apparatus in accordance with claim 1, wherein the electrode is formed of carbon.

14. An apparatus in accordance with claim 3, wherein each electrode is formed of carbon.

15. An apparatus in accordance with claim 3, wherein each electrode has the same cross-sectional area.
